(19) United States
(12) Patent Application Publication
(10) Pub. No.: US 2024/0301738 A1
(43) Pub. Date: Sep. 12, 2024

(54) METHOD AND SURROUNDINGS MONITORING SYSTEM FOR DETECTING OBJECTS IN THE SURROUNDINGS OF A VEHICLE, AND METHOD FOR DETERMINING A MOVEMENT LIMIT FOR A MOVEMENT OF A MOVABLE COMPONENT OF A VEHICLE, AND DOOR OPENING SYSTEM OR COLLISION WARNING SYSTEM FOR VEHICLE DOORS FOR CARRYING OUT THE METHOD

(71) Applicant: VALEO SCHALTER UND SENSOREN GMBH, Bietigheim-Bissingen (DE)

(72) Inventors: Alice Frapsauce, Bietigheim-Bissingen (DE); Swapnil Ashok Mahajan, Bietigheim-Bissingen (DE)

(73) Assignee: VALEO SCHALTER UND SENSOREN GMBH, Bietigheim-Bissingen (DE)

(21) Appl. No.: 18/578,312

(22) PCT Filed: Jul. 5, 2022
(86) PCT No.: PCT/EP2022/068530

§ 371 Date: Jan. 11, 2024

(30) Foreign Application Priority Data
Jul. 12, 2021 (DE) 10 2021 117 874.6

(51) Int. Cl. E05F 15/43; E05F 15/42

(52) U.S. Cl. CPC E05F 15/43; E05F 2015/433; E05F 2015/483; E05Y 2400/326; E05Y 2400/44; E05Y 2400/508; E05Y 2900/531

(57) ABSTRACT

A method for detecting objects in the surroundings of a vehicle for a door opening system or a collision warning system for vehicle doors using at least one surroundings sensor is disclosed. The vehicle includes at least one movable component. The method includes detecting objects in the surroundings of the vehicle using the at least one surroundings sensor, detecting a current position of the at least one movable component, and identifying false objects from the detected objects based on their positions between the at least one movable component in its current position and in its normal position.

The present invention relates to a method for detecting objects in the surroundings of a vehicle, in particular for a door opening system or a collision warning system for vehicle doors, with at least one surroundings sensor, wherein the vehicle has at least one movable component.

The present invention also relates to a method for determining a movement limit for a movement of a movable component of a vehicle, in particular for a door opening system or a collision warning system for vehicle doors, based on the detection of objects in the surroundings of the vehicle using at least one surroundings sensor.

The present invention furthermore relates to a surroundings monitoring system with at least one surroundings sensor for detecting objects in the surroundings of the vehicle, at least one sensor for detecting a position of at least one movable component of the vehicle, and a control unit which is connected via a data link to the at least one surroundings sensor and the at least one sensor for detecting a position of at least one movable component of the vehicle in order to receive sensor information therefrom, wherein the surroundings monitoring system is designed to carry out the above method for detecting objects in the surroundings of a vehicle.

The present invention additionally relates to a door opening system or collision warning system for vehicle doors, wherein the door opening system or the collision warning system for vehicle doors is designed to receive sensor information from at least one surroundings sensor with information relating to objects in the surroundings of the vehicle, wherein the door opening system or the collision warning system for vehicle doors has a sensor for detecting a position of the movable component.

The monitoring of the surroundings of the vehicle using surroundings sensors is becoming increasingly important in modern vehicles in order to be able to offer various driver assistance functions and implement autonomous functions with the vehicle. The monitoring of the surroundings can here be carried out using a surroundings sensor, a plurality of similar surroundings sensors, or alternatively any desired combination of surroundings sensors of different types. The monitoring of the surroundings in an immediate vicinity of up to five to ten meters is often effected by ultrasonic sensors which emit ultrasonic pulses and receive reflections of the emitted ultrasonic pulses on objects in the surroundings as ultrasonic echoes. The distances of objects can be established based on the length of time from the emitting of the ultrasonic pulses to the receipt of the ultrasonic echoes.

The monitoring of the surroundings is typically effected for the surroundings sensors in their field of view based on calibrated parameters in order to detect the objects in the field of view. The field of view can here be configured in a partially dynamic fashion. To do this, sensor parameters can be adapted, parts of the field of view can be blanked out, or the field of view can be adapted. These configurations can be implemented, for example, by software modifications.

Although the surroundings sensors as a whole function reliably, it is frequently possible that false objects are detected. This means that the surroundings sensors detect an object at a position in the surroundings of the vehicle at which no actual object is situated. It is possible that, despite the described configuration, such false objects are also detected in the case of the ultrasonic sensors. This is the case in particular when the options for configuring the ultrasonic sensors are not used or cannot be used.

This problem is amplified by movable components of the vehicle because, on the one hand, surroundings sensors can be arranged on the movable components and thus move with the latter, and, on the other hand, the movable components can reflect the emitted ultrasonic pulses. The movable components can here not only themselves be detected as false objects but also result in false objects being detected at other positions because of ultrasonic reflections. The same applies to the use of ultrasonic sensors attached to the movable components, wherein ultrasonic reflections which result in false objects being detected can also occur on the body of the vehicle and/or other movable components. In principle, when ultrasonic sensors are used, errors can also occur because of ultrasonic pulses radiated by other ultrasonic sensors which are detected as false objects. The said errors can therefore arise, for example, because, when a front door of the vehicle is open, ultrasonic sensors at the rear door can detect a false object in front of or behind the front door, in particular when the rear door is opened. When the rear door of the vehicle is open, ultrasonic sensors at the front door can detect a false object in front of or behind the front door, in particular when the front door is opened. The said errors thus relate to detection of false objects as a result of reflections on the movable components and/or detection of false objects using ultrasonic sensors attached to the movable components as a result of reflections which occur on other objects, for example on other vehicle components, in addition to the detection of the movable components.

In spite of the problems mentioned, the monitoring of the surroundings in the region of movable components is particularly important and is therefore carried out increasingly frequently. This is the case, for example, for electronically controlled opening or closing of vehicle doors or the issuing of collision warnings for vehicle doors to people who are moving the vehicle doors by hand in order to open or close them. When false objects are detected, it can occur that the vehicle doors cannot open fully or cannot be opened fully when manually manipulated by the people. The same applies to the closing of the vehicle doors such that the vehicle doors cannot close fully or cannot be closed fully when manually manipulated by the people when a false object is detected between a current position of the corresponding vehicle door and the vehicle door in its closed position. When false objects are detected between the vehicle door in its current position and in the closed position, the system can also shift into an error mode in which the vehicle door can no longer be moved.

A critical point is determined, for the movement of the vehicle doors usually based on objects in front of the respective vehicle door in the opening direction, as a movement limit which limits a movement of the corresponding vehicle door. A critical opening angle is often defined in the case of pivotable vehicle doors. Accordingly, surroundings sensors are often attached to the vehicle in the vicinity of the movable components. The surroundings sensors are sometimes even attached directly to the movable components.

In this connection, DE 10 2019 102624 A1 discloses a method for detecting objects in the surroundings of a vehicle using a surroundings sensor, wherein the surroundings sensor is attached to a movable vehicle part of the vehicle in a sensor position. The method comprises the steps of receiving sensor information from the surroundings sensor from the surroundings of the vehicle, determining a relative position of at least one object with respect to the surroundings sensor based on the sensor information, detecting a movement position of the movable vehicle part, and determining an absolute position of the at least one object with reference to the vehicle based on the relative position of the at least one object, the movement position of the movable vehicle part, and the sensor position of the surroundings sensor at the movable vehicle part. Also disclosed is a driver assistance system for a vehicle with a surroundings sensor which is attached to a movable vehicle part of the vehicle in a sensor position, and a movement sensor for detecting a movement position of the movable vehicle part. The driver assistance system is designed to carry out the above method for detecting objects in the surroundings of the vehicle.

Furthermore, DE 10 2014 118 318 A1 discloses a method for detecting an object in an opening range of a first door of a motor vehicle by means of at least one first distance sensor. The at least one first distance sensor is arranged in and/or at the first door and has a detection range in which a current opening angle of the first door is detected and the detection range is adapted depending on the detected opening angle. A status variable of at least one part of the motor vehicle other than the first door is determined which describes a position and/or an operating setting of the at least one part. In addition, the detection range of the at least one first distance sensor is adapted depending on the determined status variable.

DE 10 2013 218 571 A1 relates to a device for detecting the lateral surrounding area of a motor vehicle and to a method for simultaneously operating a parking assistance device and a door protection device, wherein the parking assistance device and the door protection device undertake detection of the surrounding area using surrounding area sensors of the same structure. In order to be able to operate them simultaneously or in an overlapping fashion without interference caused by cross echo pulses occurring, it is proposed to operate the simultaneously operated surrounding area sensors at frequencies which are shifted relative to one another and at least one of the frequencies of which is also shifted with respect to a resonating frequency of the surrounding area sensors.

Starting from the abovementioned prior art, the object of the invention is thus to provide a method for detecting objects in the surroundings of a vehicle, a method for determining a movement limit for a movement of a movable component of a vehicle, a surroundings monitoring system for detecting objects in the surroundings of the vehicle, and a door opening system or collision warning system for vehicle doors, which overcome at least some of the abovementioned disadvantages. The object of the present invention is in particular to provide a method for detecting objects in the surroundings of a vehicle, a method for determining a movement limit for a movement of a movable component of a vehicle, a surroundings monitoring system for detecting objects in the surroundings of the vehicle, and a door opening system or collision warning system for vehicle doors, which reduce or avoid the need to take false echoes into account.

The object is achieved according to the invention by the features of the independent claims. Advantageous embodiments of the invention are specified in the dependent claims.

According to the invention, a method is thus provided for detecting objects in the surroundings of a vehicle, in particular for a door opening system or a collision warning system for vehicle doors, using at least one surroundings sensor, wherein the vehicle has at least one movable component, comprising the steps of detecting objects in the surroundings of the vehicle using the at least one surroundings sensor, detecting a current position of the at least one movable component, and identifying false objects from the detected objects based on their positions between the at least one movable component in its current position and in its normal position.

According to the invention, a method is also provided for determining a movement limit for a movement of a movable component of a vehicle, in particular for a door opening system or a collision warning system for vehicle doors, based on the detection of objects in the surroundings of the vehicle using at least one surroundings sensor, comprising the steps of detecting objects in the surroundings of the vehicle using the at least one surroundings sensor, in particular according to the above method, and establishing a movement limit of the movable component from its normal position based on the detected objects in the surroundings of the vehicle with no false objects.

A surroundings monitoring system is further provided according to the invention with at least one surroundings sensor for detecting objects in the surroundings of the vehicle, at least one sensor for detecting a position of at least one movable component of the vehicle, and a control unit which is connected via a data link to the at least one surroundings sensor and the at least one sensor for detecting a position of at least one movable component of the vehicle in order to receive sensor information therefrom, wherein the surroundings monitoring system is designed to carry out the above method for detecting objects in the surroundings of a vehicle.

Additionally, a door opening system or collision warning system for vehicle doors is provided according to the invention, wherein the door opening system or the collision warning system for vehicle doors is designed to receive sensor information from at least one surroundings sensor with information relating to objects in the surroundings of the vehicle, wherein the door opening system or the collision warning system for vehicle doors has a sensor for detecting a position of the movable component, wherein the door opening system or the collision warning system is designed to carry out the above method for determining a movement limit for a movement of a movable component of a vehicle.

The fundamental idea of the present invention in the abovementioned aspects is thus, based on the positions of detected objects in the surroundings of the vehicle, to identify as false objects those objects which have positions situated between the at least one movable component in its current position and in its normal position. This region has been covered by the movable component with its movement from its normal position into its current position such that usually no objects can be situated there. Nevertheless, it has been established in practice and in laboratory tests that objects which are not present in this region, i.e. false objects, can be detected. In particular when the monitoring and/or controlling of movable components is to be carried out, it is often advantageous or even necessary to install corresponding surroundings sensors in the vicinity of the movable components or even on the movable components. However, in practice, this results in the fact that the said false objects can be detected. These false objects can be filtered or labeled according to the invention such that they can be not taken into account for further processing. For example, for ultrasonic sensors the detection of false objects can also be referred to as a ghost echo. The ghost echoes can as a result of reflections on the movable components and/or the detection of false objects using ultrasonic sensors attached to the movable components based on reflections which occur on other objects, for example on other vehicle components.

According to the invention, reliable detection of objects in the surroundings of a vehicle, reliable determining of a movement limit for a movement of a movable component of a vehicle, a surroundings monitoring system for avoiding or reducing the detection of false objects, and a reliable door opening system or collision warning system for vehicle doors can thus be provided.

The door opening system performs a drive function for autonomous movement of the corresponding vehicle door or for power assistance when moving the vehicle door. The collision warning system monitors a manual movement of the vehicle door and specifies in advance and/or during the movement of the vehicle door a remaining amount of room for the movement of the vehicle door. In the case of an imminent collision of the vehicle door with an object, both systems can issue an acoustic, optical, and/or haptic warning.

The at least one surroundings sensor can be an ultrasonic sensor, a radar sensor, a LiDAR-based surroundings sensor, or alternatively an optical camera. The surroundings monitoring system preferably comprises a plurality of surroundings sensors, for example a plurality of ultrasonic sensors which can be attached to the vehicle at any desired positions, including on the at least one movable component. The surroundings monitoring system particularly preferably comprises a combination of different types of surroundings sensors in in each case any desired number and arrangement.

The vehicle can per se be any kind of vehicle which has at least one corresponding movable component. Movable components can be, for example, vehicle doors, in particular side doors or tailgates, or alternatively steerable wheels of the vehicle. In principle, lids such as, for example, a trunk lid or a hood can also constitute movable components within the sense of the present invention.

Detection of the current position of the at least one movable component is typically made via a separate sensor, for example an angle sensor for vehicle doors. Alternatively or additionally, the current position of the at least one movable component can be detected using a surroundings sensor or using a plurality of surroundings sensors.

The movement limit for a movement of the movable component of a vehicle is preferably established in the direction of movement of the movable component away from its normal position. The normal position can here be dependent on the type of movable component. For a vehicle door, the normal position is usually defined by the position of the vehicle door in the closed state. In this position, the vehicle has its smallest external dimensions. Correspondingly, the normal position, for example for steerable wheels of the vehicle, can be a straight-ahead position of the wheels, two possible directions of movement resulting in this case. Establishing the movement limit can comprise establishing the closest object in the direction of movement which can limit a movement of the movable component in this direction. The respective movement limit can be established based on this closest object. In order to reliably establish the movement limit, false objects are not taken into account.

The movement limit can be established based on 2D positions of the detected objects, i.e. each detected object is projected onto a plane. Alternatively, the movement limit can be established based on 3D positions of the detected objects.

Objects which are not relevant for a movement of the movable components because, for example, of an elevated position can thus be not taken into account. Moreover, further parameters can feed into the establishing of the movement limit, for example inaccuracy ranges of the positions of the detected objects, confidence in the detection of the objects using the at least one surroundings sensor, an age of the detected objects, sensor parameters of the surroundings sensors, detection of the objects by one specific surroundings sensor or by a plurality of surroundings sensors, or otherwise.

When objects are detected in the surroundings of the vehicle using the at least one surroundings sensor according to the above method, false objects are identified in advance and can thus be labeled or filtered such that they can be not taken into account when establishing the movement limit.

The surroundings monitoring system detects objects in the surroundings of the vehicle, as was described in detail above. The detection of the objects can be carried out in order jointly to provide information relating to objects situated in the surroundings, for example for use by driver assistance systems of the vehicle which use this information. The surroundings monitoring system can correspondingly also be part of a corresponding driver assistance system.

The surroundings monitoring system comprises a control unit which is connected via a data link to the at least one surroundings sensor and the at least one sensor for detecting a position of at least one movable component of the vehicle. In principle, the sensors can also be provided independently on the vehicle. It is sufficient if the sensors transmit their sensor information to the control unit. The data link is preferably designed as a data bus. In principle, any topologies and transmission protocols can be used. Data buses known as CAN, LON, or FlexRay are widely found in the automotive sector.

The door opening system or the collision warning system for vehicle doors is designed to receive sensor information from the at least one surroundings sensor relating to objects in the surroundings of the vehicle. Based thereon, the door opening system or the collision warning system for vehicle doors can detect the surroundings of the vehicle in particular in the vicinity of the corresponding vehicle doors. The surroundings sensors can be part of the door opening system or the collision warning system. Alternatively, the surroundings sensors can also be provided on the vehicle independently of the door opening system or the collision warning system. It is sufficient if the sensors transmit their sensor information to the door opening system or the collision warning system. The same applies for the sensor for detecting a position of the movable component.

In an advantageous embodiment of the invention, the method comprises a step of creating a map of the surroundings with the detected objects in the surroundings of the vehicle. The map of the surroundings is a map which is usually defined for the vehicle and constitutes a common reference for all the surroundings sensors. All the detected objects can be represented together in the map of the surroundings such that in particular objects which are detected by different surroundings sensors can be placed simply with reference to one another. Sensor information from different surroundings sensors can also be merged in order to reliably detect objects. After the false objects have been identified, these false objects can, for example, be removed from the map of the surroundings or labeled as false objects. The map of the surroundings typically represents a 2D projection of the detected objects into the plane of the map. Information on their vertical position or their vertical extent can additionally be assigned to the objects in the map of the surroundings. The movable component can also be represented in the map of the surroundings based on the position of the at least one movable component. Additionally, at least one false identification region can be defined in the map of the surroundings which is situated between the at least one movable component in its current position and in its normal position. Detected objects in the false identification region can thus simply be identified as false objects.

In an advantageous embodiment of the invention, the detection of a current position of the movable component comprises detecting a current angular position of the movable component. The movable component is preferably a vehicle door which is held pivotably on a body of the vehicle. The vehicle door can usually be pivoted about a vertical axis. The current angular position of the movable component corresponds to an angle between the movable component in its current position compared with its normal position, i.e. in a closed state.

In an advantageous embodiment of the invention, the method comprises a step of detecting a movement of the at least one movable component based on a change to the detected position of the at least one movable component, and the identification of false objects from the detected objects based on their positions between the at least one movable component in its current position and in its normal position is effected whilst additionally taking into account the detected movement of the at least one movable component. The movement of the at least one movable component results in a changed detection situation of the surroundings by the at least one surroundings sensor. In the case of a movement of the at least one movable component, it is usually assumed that changes also result for false objects such that previously detected false objects disappear and/or other false objects, in particular at other positions, are detected. If this is not the case, no false object has been identified and instead an actual object is situated in a position between the at least one movable component in its current position and in its normal position. The movement of the at least one movable component can be a movement of that movable component for which at least one false object was identified in a position between the current position and its normal position. The movement can alternatively or additionally be a movement of a different movable component. In each case, a change in the surroundings results from a movement of at least one movable component, as a result of which changes result for the detection of the objects and in particular for the identification of the false objects. The above explanations with reference to the movement of the at least one movable component apply irrespective of the attachment of surroundings sensors to the movable components.

In an advantageous embodiment of the invention, the method comprises a step of detecting a change in a configuration of the at least one surroundings sensor, and the identification of false objects from the detected objects based on their positions between the at least one movable component in its current position and in its normal position is effected whilst additionally taking into account the detected change in the configuration of the at least one surroundings sensor. The change in the configuration of the at least one movable component results in a changed detection situation in the surroundings of the vehicle. Also in the case of a change in the configuration of the at least one surroundings sensor, it is usually assumed that changes also result for false objects such that previously detected false objects disappear and/or other false objects, in particular at other positions, are detected. If this is not the case, no false object has been identified and instead an actual object is situated in a position between the at least one movable component in its current position and in its normal position. The change in the configuration can comprise a change in the field of view, blanking out of parts of the field of view, or in the case of ultrasonic sensors a change in the frequency of the emitted ultrasonic pulses. The change in the configuration can be performed, for example, by a software modification or software configuration.

In an advantageous embodiment of the invention, the method comprises a step of detecting the length of time taken to detect objects in the surroundings of the vehicle, and the identification of false objects from the detected objects based on their positions between the at least one movable component in its current position and in its normal position is effected whilst additionally taking into account the length of time taken to detect the false objects at their positions between the at least one movable component in its current position and in its normal position. The detection of an object over a relatively long period of time serves as an indicator that a detected object is an actual object. In contrast, in the case of false objects, the detection can change, i.e. the false object changes its position and/or the false object is only temporarily present.

In an advantageous embodiment of the invention, establishing a movement limit of the movable component from its normal position based on the detected objects in the surroundings of the vehicle comprises the application of a hysteresis. The hysteresis stabilizes a position and thus also a change in position of the movable component such that smaller variations in the detection of the objects, as can occur in practice because of tolerances, are not taken into account. As a result, for example, changes in the detected position of objects which are not based on a movement of the corresponding objects can be not taken into account. In the case of pivotable vehicle doors, a hysteresis angle of preferably approximately +/−3º can, for example, be set in order to stabilize the establishing of the current movement limit of the movable component. Accordingly, a hysteresis for the detection of the current position of the at least one movable component can also be applied.

In an advantageous embodiment of the invention, the method comprises a step of detecting a movement pause in the movement of the movable component, wherein the establishing of the movement limit of the movable component is suspended in the movement pause. If the movable component does not move or is not moved and the objects in the surroundings of the vehicle also do not move, the positions of the detected objects should be stable, in particular for actual objects as opposed to false objects. Accordingly, for the movement pause it can be assumed that the movement limit also does not change. The determination of the movement limit is thus stable because false objects and movement limits based thereon can simply be ignored. For example, for pivotable vehicle doors, the critical angle for opening the door can be frozen when the current angle of the corresponding vehicle door does not change. A movement pause exists when the position of the corresponding movable component does not change for a defined period of time which can be established independently for each movable component and can be set individually for each movable component. As soon as the position of the corresponding movable component changes again, i.e. a movement of the movable component occurs, the movement pause ends and the movement limit of the movable component is established again as before the movement pause.

According to the invention, a method is additionally provided for determining a movement limit for a movement of a movable component of a vehicle, in particular for a door opening system or a collision warning system for vehicle doors, based on the detection of objects in the surroundings of the vehicle with at least one surroundings sensor, comprising the steps of detecting objects in the surroundings of the vehicle using the at least one surroundings sensor, establishing a current movement limit of the movable component based on the detected objects in the surroundings of the vehicle, detecting a current position of the movable component, and accepting the current movement limit when the current movement limit is not situated in a position between the movable component in its current position and in its normal position.

The fundamental idea of this method is to apply the above principles for identifying false objects in the surroundings of the vehicle immediately without first carrying out an explicit check of the detected objects in order to identify the false objects. Rather, the false objects are taken into account immediately by a check being made when the movement limit is adapted as to whether the new movement limit is not situated in a position between the movable component in its current position and in its normal position. In this case, the new movement limit is based, in accordance with the above explanations, on detection of a false object and is not accepted. Only new movement limits which are situated in front of the component in the direction of movement of the movable component are accepted. Thus, for example, in the case of a pivotable vehicle door, a critical angle is determined as the movement limit where it is unchanged until the new critical angle is greater than a current opening angle of the vehicle door. This configuration of the method is advantageous in particular in the case of a cyclical design when a current movement limit is to be used at a regular interval. It is thus ensured that in each case a current movement limit which is not based on a false object is used.

In the case of cyclical detection of a current position of the movable component, this position can be assigned a time stamp. This enables correct estimation of a distance from an object or a “time of flight” in particular in the case of moving surroundings sensors, as is the case for example with ultrasonic sensors attached to a vehicle door. Consequently, positions of objects can be reliably established by trilateration of the distance or the “time of flight”, as a result of which a method which is carried out cyclically is particularly reliable.

The description made above with reference to the individual aspects of the invention, namely the method as well as the surroundings monitoring system and the door opening system or collision warning system for vehicle doors, with details, embodiments, advantages, and variants can in each case be transferred correspondingly to other aspects of the invention as are readily apparent to a person skilled in the art starting from the description.

The invention is explained in more detail below with reference to the attached drawings on the basis of preferred embodiments. The features shown can each constitute an aspect of the invention both individually and in combination. Features of different exemplary embodiments can be transferred from one exemplary embodiment to another.

In the drawings:

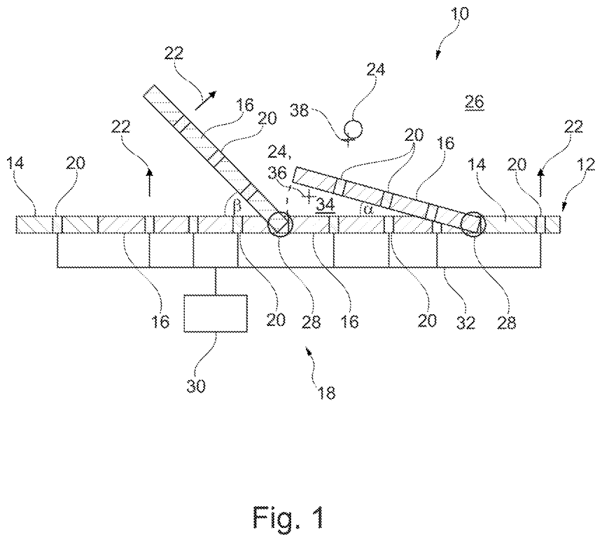

FIG. 1 shows a schematic partial illustration of a vehicle with two vehicle doors, wherein the vehicle is designed with a surroundings monitoring system with a plurality of ultrasonic sensors, according to a first preferred embodiment,

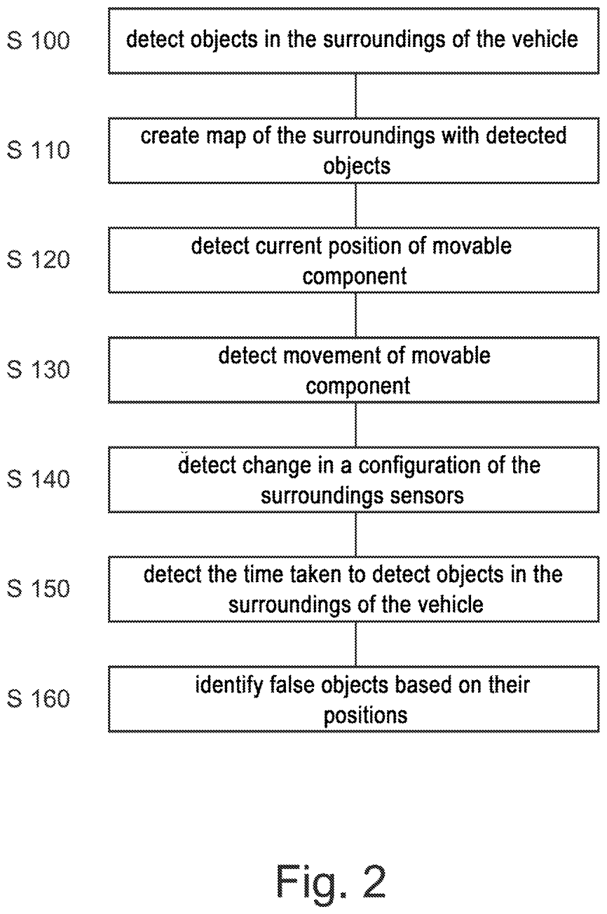

FIG. 2 shows a flow diagram of a method for detecting objects in the surroundings of the vehicle from FIG. 1 according to a second embodiment,

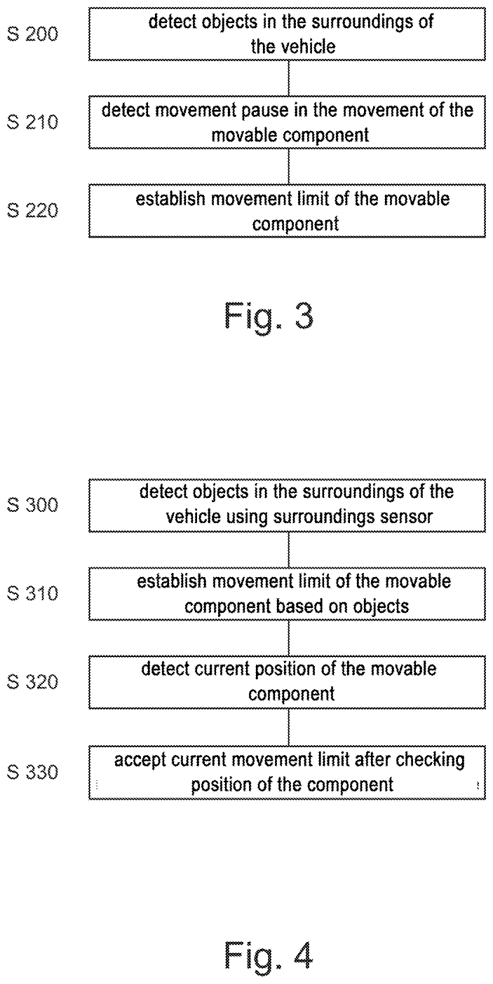

FIG. 3 shows a flow diagram of a method for determining a movement limit for a movement of a movable component of the vehicle from FIG. 1 according to a third embodiment, and

FIG. 4 shows a flow diagram of a method for determining a movement limit for a movement of a movable component of the vehicle from FIG. 1 according to a fourth embodiment.

FIG. 1 shows (part of) a vehicle 10 with a vehicle side 12. Part of the body 14 of the vehicle 10 on which two vehicle doors 16 are held pivotably is shown in FIG. 1. The vehicle doors 16 are illustrated both in a normal position which corresponds to a closed position of the vehicle doors 16 and in each case in an open position. The vehicle doors 16 are movable components 16 of the vehicle 10 within the sense of the present invention.

The vehicle 10 is designed with a surroundings monitoring system 18. The surroundings monitoring system 18 comprises a plurality of surroundings sensors 20 which are arranged on the body 14 and the vehicle doors 16. In this exemplary embodiment, the surroundings sensors 20 are designed as ultrasonic sensors 20. The ultrasonic sensors 20 are designed to radiate ultrasonic pulses in a radiation direction 22 away from the vehicle 10, i.e. away from the body 14 and the vehicle doors 16, and to receive ultrasonic echoes based thereon. Objects 24 in the surroundings 26 of the vehicle 10 with their positions can be detected on the basis of the received ultrasonic echoes.

The surroundings monitoring system 18 furthermore comprises a sensor 28 for detecting a position of each of the two vehicle doors 16. Each of the sensors 28 detects an angular position α, β of the assigned vehicle door 16.

The surroundings monitoring system 18 additionally comprises a control unit 30 which is connected via a data link 32 to the ultrasonic sensors 20 and to the sensors 28 for detecting the position of the respective vehicle door 16 of the vehicle 10 in order to receive sensor information therefrom. The data link 32 is preferably designed as a data bus 32. In principle, any topologies and transmission protocols can be used. Data buses 32 known as CAN, LON, or FlexRay are widely found in the automotive sector.

The surroundings monitoring system 18 is here part of a door opening system or a collision warning system for vehicle doors 16. In this exemplary embodiment, the door opening system or collision warning system for vehicle doors 16 is designed integrally with the surroundings monitoring system 18. Additional functionality of the door opening system or the collision warning system for vehicle doors 16 is implemented in the control unit 30 of the surroundings monitoring system 18.

The door opening system performs a drive function for autonomous movement of the corresponding vehicle door 16 or for power assistance when moving the vehicle door 16. The collision warning system monitors a manual movement of the vehicle door 16 and specifies in advance and/or during the movement of the vehicle door 16 a remaining amount of room for movement of the vehicle door 16. In the case of an imminent collision of the vehicle door 16 with an object 24, both systems can issue an acoustic, optical, and/or haptic warning.

A method for detecting objects 24 in the surroundings 26 of the vehicle 10 according to a second embodiment will be described below with reference to FIG. 2. The method is carried out by the surroundings monitoring system 18 of the first embodiment.

The method starts with step S100, which relates to the detection of objects 24 in the surroundings 26 of the vehicle 10 using the ultrasonic sensors 20. The monitoring of the surroundings 26 for the purpose of detecting objects 24 situated there using ultrasonic sensors 20 is known as such.
Step S110 relates to establishing a map of the surroundings with the detected objects 24 in the surroundings 26 of the vehicle 10. The map of the surroundings is a map which is defined for the vehicle 10 and constitutes a common reference for all the surroundings sensors 20. All the detected objects 24 are represented together in the map of the surroundings. Sensor information from the ultrasonic sensors 20 can be merged in order to reliably detect the objects 24. The map of the surroundings represents a 2D projection of the detected objects into the plane of the map. Information on their vertical position or their vertical extent is additionally assigned to the objects 24 in the map of the surroundings where it can be detected by the ultrasonic sensors 20.
Step S120 relates to the detection of a current position of each of the vehicle doors 16. The positions of the vehicle doors 16 are detected using the sensors 28 for the purpose of detecting the angular position α, β of the respective vehicle door 16 of the vehicle 10. The angular position α, β of the respective vehicle door 16 corresponds to an angle between the vehicle door 16 in its current position, i.e. in the open state, compared with its normal position in a closed state. Alternatively or additionally, the current position of the vehicle doors 16 can be detected using the ultrasonic sensors 20 attached to the body 14.

A position of the vehicle doors 16 is also represented in the map of the surroundings in addition to the detected objects 24. Additionally, a false identification region 34 can be defined in the map of the surroundings which is situated between the respective vehicle door 16 in its current position and in its normal position.
Step S130 relates to the detection of a movement of the vehicle doors 16 based on a change in the detected position of the respective vehicle door 16.
Step S140 relates to the detection of a change in a configuration of the ultrasonic sensors 20. The change in a configuration of the ultrasonic sensors 20 can be performed during operation, preferably by the control unit 30 or with the control unit 30. The change in the configuration can comprise a change in the field of view, blanking out of parts of the field of view, a change in the frequency of the emitted ultrasonic pulses, etc. The change in the configuration is performed by a software modification or software configuration of the ultrasonic sensors 20.
Step S150 relates to the detection of the length of time it takes to detect the objects 24 in the surroundings 26 of the vehicle 10. How long the respective objects 24 have been situated in the surroundings 26 of the vehicle 10 and low long the respective objects 24 have been situated at their current position is detected.
Step S160 relates to the identification of false objects 36 from the detected objects 24 based on their positions between the respective vehicle door 16 in its current position and in its normal position. Objects 24 situated in the false identification region 34 are thus detected as false objects 36.

In addition, the detected movement of the vehicle doors 16, the length of time taken to detect the false objects 36 in the false identification region 34, and a detected change in the configuration of the ultrasonic sensors 20 are taken into account. The movement of the vehicle door 16 can be a movement of that vehicle door 16 for which at least one false object 36 has been identified in the false identification region 34. The movement of the vehicle door 16 can alternatively or additionally be a movement of a different vehicle door 16.

The movement of the respective vehicle door 16 and the change in the configuration of the ultrasonic sensors 20 in each case result in a changed detection situation of the surroundings 26 using the ultrasonic sensors 20. On the basis of the changed detection situation, changes often also result for false objects 36 such that previously detected false objects 36 disappear, i.e. are no longer detected, and/or other false objects 36, in particular at other positions, are detected. If this is not the case, no false object 36 has been identified and instead an actual object 24 is situated in the false identification region 34.

The detection of an object 24 over a relatively long period of time serves as an indicator that a detected object 24 is an actual object 24. In contrast, in the case of false objects 36, the detection can change, i.e. the false object 36 changes its position and/or the false object 36 is only temporarily present.

The identified false objects 36 are filtered or labeled in the map of the surroundings, i.e. the false objects 36 are removed from the map of the surroundings or labeled as false objects 36. For the ultrasonic sensors 20, the detection of false objects 36 is also referred to as ghost echoes.

A method according to a third embodiment for determining a movement limit 38 for a movement of the vehicle doors 16 of the vehicle 10 from FIG. 1 is described below with reference to FIG. 3. The method for determining a movement limit 38 for a movement of the vehicle doors 16 of the vehicle 10 is based on the detection of the objects 24 in the surroundings 26 of the vehicle 10 using the ultrasonic sensors 20.

The method begins with step S200 for the detection of the objects 24 in the surroundings 26 of the vehicle 10 with the method, described above with reference to FIG. 2, of the second embodiment.
Step S210 relates to the detection of a movement pause in the movement of the vehicle door 16. A movement pause exists when the angular position α, β of the corresponding vehicle door 16 does not change for a defined length of time. The defined length of time can here be established independently for each vehicle door 16 and can be set individually for each vehicle door 16. As soon as the angular position α, β of the corresponding vehicle door 16 changes again, i.e. a movement of the vehicle door 16 takes place, the movement pause ends and the movement limit 38 of the vehicle door 16 is established again as before the movement pause with the following step S220.
Step S220 relates to establishing the movement limit 38 of the respective vehicle door 16 from its normal position based on the detected objects 24 in the surroundings 26 of the vehicle 10 with no false objects 36.

The movement limit 38 for the movement of the respective vehicle door 16 is established in the direction of movement of the vehicle door 16 away from the normal position, i.e. away from the closed position of the vehicle door 16. Establishing the movement limit 38 is based on the object 24 closest in the direction of movement which limits movement of the corresponding vehicle door 16 in this direction.

The movement limit 38 can be established based on 2D positions of the detected objects 24 in the map of the surroundings. Moreover, further parameters can feed into the establishing of the movement limit 38, for example inaccuracy ranges of the positions of the detected objects 24, confidence values for the detection of the objects 24 using the ultrasonic sensors 20, an age of the detected objects 24, sensor parameters of the ultrasonic sensors 20, detection of the objects 24 by one specific ultrasonic sensor 20 or by a plurality of ultrasonic sensors 20, or otherwise.

In addition, a hysteresis function is applied in order to stabilize a position of the vehicle door 16 as well as changes in the detected position of objects 24. In the case of pivotable vehicle doors 16, a hysteresis angle of preferably approximately +/−3º can, for example, be set in order to stabilize the establishing of the current movement limit 38.

A method according to a fourth embodiment for determining a movement limit 38 for a movement of the vehicle doors 16 of the vehicle 10 from FIG. 1 is described below with reference to FIG. 4. The method of the fourth embodiment for determining a movement limit 38 for a movement of the vehicle doors 16 of the vehicle 10 is also based on the detection of the objects 24 in the surroundings 26 of the vehicle 10 using the ultrasonic sensors 20. Unlike the method of the third embodiment, however, no explicit check of the detected objects 24 in order to identify false objects 36 is made in the method of the fourth embodiment. Rather, the false objects 36 are immediately taken into account by a check being made during the adaptation of the movement limit 38 as to whether the new movement limit 38 is or is not situated in the false identification region 34.

The method starts with step S300, with the detection of objects 24 in the surroundings 26 of the vehicle 10 using the ultrasonic sensors 20. Step S300 essentially corresponds to the above described step S100.
Step S310 relates to establishing a current movement limit 38 of the vehicle door 16 based on the detected objects 24 in the surroundings 26 of the vehicle 10.

The current movement limit 38 of the corresponding vehicle door 16 is established in a similar fashion to that described in S220, wherein in this case false objects 36 can also be taken into account for establishing the current movement limit 38 of the vehicle door 16 when these false objects 36 are situated closest to the normal position of the vehicle door 16 in the direction of movement of the latter.
Step S320 relates to the detection of a current position of the vehicle door 16. The above explanations apply with reference to the detection of the current position of the vehicle doors 16 in step S120.
Step S330 relates to accepting the current movement limit 38 when the current movement limit 38 is not situated in the false identification region 34. The current movement limit 38 is thus only accepted when it is situated in front of the vehicle door 16, away from the normal position, in the direction of movement of the vehicle door 16.

As is apparent from the preceding description, the described sequence of method steps only specifies options for carrying out the corresponding method. Alternative sequences of the individual method steps are also possible, as is clear to a person skilled in the art from the preceding description.

### LIST OF REFERENCE SIGNS

10 vehicle
12 vehicle side
14 body
16 vehicle door, movable component
18 surroundings monitoring system
20 ultrasonic sensor, surroundings sensor
22 direction of radiation
24 object
26 surroundings
28 sensor
30 control unit
32 data link, data bus
34 false identification region
36 false object
38 movement limit
α angular position
β angular position

1. A method for detecting objects in the surroundings of a vehicle, for a door opening system or a collision warning system for vehicle doors, using at least one surroundings sensor,
wherein the vehicle comprises at least one movable component,
the method comprising:
detecting objects in the surroundings of the vehicle using the at least one surroundings sensor;
detecting a current position of the at least one movable component; and
identifying false objects from the detected objects based on their positions between the at least one movable component in its current position and in its normal position.

2. The method as claimed in claim 1,
the method further comprising creating a map of the surroundings with the detected objects in the surroundings of the vehicle.

3. The method as claimed in claim 1,
wherein the detection of a current position of the movable component comprises detecting a current angular position of the movable component.

4. The method as claimed in claim 1,
the method further comprising detecting a movement of the at least one movable component based on a change in the detected position of the at least one movable component, and
wherein the identification of false objects from the detected objects based on their positions between the at least one movable component in its current position and in its normal position additionally takes into account the detected movement of the at least one movable component.

5. The method as claimed in claim 1,
the method further comprising detecting a change in a configuration of the at least one surroundings sensor, and
wherein the identification of false objects from the detected objects based on their positions between the at least one movable component in its current position and in its normal position additionally takes into account the detected change in the configuration of the at least one surroundings sensor.

6. The method as claimed in claim 1,
the method further comprising detecting the length of time taken for detecting objects in the surroundings of the vehicle, and
wherein the identification of false objects from the detected objects based on their positions between the at least one movable component in its current position and in its normal position additionally takes into account the length of time taken to detect the false objects at their positions between the at least one movable component in its current position and in its normal position.

7. A method for determining a movement limit for a movement of a movable component of a vehicle for a door opening system or a collision warning system for vehicle doors,
wherein the method is based on the detection of objects in the surroundings of the vehicle using at least one surroundings sensor,
the method comprising:
detecting objects in the surroundings of the vehicle using the at least one surroundings sensor as claimed in claim 1, and
establishing a movement limit of the movable component from its normal position based on the detected objects in the surroundings of the vehicle with no false objects.

8. The method as claimed in claim 7,
wherein establishing a movement limit of the movable component from its normal position based on the detected objects in the surroundings of the vehicle comprises the application of a hysteresis.

9. The method as claimed in claim 7,
the method further comprising detecting a movement pause of the movement of the movable component,
wherein the establishing of the movement limit of the movable component is suspended in the movement pause.

10. A method for determining a movement limit for a movement of a movable component of a vehicle for a door opening system or a collision warning system for vehicle doors,
wherein the method is based on detecting objects in the surroundings of the vehicle by at least one surroundings sensor,
the method comprising:
detecting objects in the surroundings of the vehicle using the at least one surroundings sensor,
establishing a current movement limit of the movable component based on the detected objects in the surroundings of the vehicle,
detecting a current position of the movable component, and
accepting the current movement limit when the current movement limit is not situated in a position between the movable component in its current position and in its normal position.

11. A surroundings monitoring system comprising:
at least one surroundings sensor for detecting objects in the surroundings of the vehicle;
at least one sensor for detecting a position of at least one movable component of the vehicle; and
a control unit which is connected via a data link to the at least one surroundings sensor and the at least one sensor for detecting a position of at least one movable component of the vehicle in order to receive sensor information therefrom,
wherein the surroundings monitoring system is configured to detect objects in the surroundings of a vehicle using the at least one surroundings sensor as claimed in claim 1.

12. A door opening system or collision warning system for vehicle doors,
wherein the door opening system or the collision warning system for vehicle doors is configured to receive sensor information from at least one surroundings sensor with information relating to objects in the surroundings of the vehicle,
wherein the door opening system or the collision warning system for vehicle doors comprises a sensor for detecting a position of a movable component,
wherein the door opening system or the collision warning system is configured to determine a movement limit for a movement of a movable component of a vehicle based on the detected objects in the surroundings of the vehicle with no false objects as claimed in claim 7.
